(19) United States
(12) Patent Application Publication
(10) Pub. No.: US 2007/0119680 A1
(43) Pub. Date: May 31, 2007

(54) Banknote recycler protocol adapter

(76) Inventors: Leon Saltsov, Thornhill (CA); Yuri Rusakov, Etobicoke (CA); Dmitro Baydin, Toronto (CA); Bogdan Mishunn, Toronto (CA)

Correspondence Address: Dennison Associates, Suite 301, 133 Richmond Street West, Toronto, ON, M5H 2L7, CA

(21) Appl. No.: 11/583,818

(22) Filed: Oct. 20, 2006

(30) Foreign Application Priority Data
Oct. 20, 2005 (CA) 2,523,925

(51) Int. Cl. G07F 7/04

(52) U.S. Cl. 194/206

(57) ABSTRACT

Vending or gaming machines typically use a communication protocol such as a MDB (multi drop bus) communication protocol to allow effective communication between a host controller and a series of peripheral devices including bill validators and coin changers. An intelligent adapter is provided to allow communication with a banknote validator and recycler to allow banknotes to be provided as change without updating the protocol of the vending or gaming machine. The intelligent adapter acts as an intermediary whereby the peripheral connected thereto opposite in their normal manner and the host controller operates in a manner supported by its protocol. The intelligent adaptor is used to provide the recycling banknote function as an additional capability of the coin changer and appropriately readdresses or coordinates the signals to or from the peripheral devices to the host controller.

### FIELD OF THE INVENTION

The present invention relates to an arrangement for modifying an existing vending or gaming machine designed to operate in association with a standard bill validator and coin changer to allow operation of this device with a banknote recycler using the existing communication protocol of the vending or gaming machine.

### BACKGROUND OF THE INVENTION

There are a host of existing vending or gaming machines that operate based on a MDB (multi drop bus) host controller that is designed to control a series of peripheral devices connected thereto by a communication bus. The MDB (multi drop bus) controller sends addressed communications to the various standard peripheral devices and receives signals from these devices.

The protocol (Multi Drop Bus/Interface Communication Protocol (MDB/ICP) Standard Version 3.0) used by the MDB (multi drop bus) controller can be updated in a number of different ways to accommodate a new device having an extended set of features. In particular, it is now desirable to include as part of a bill validator, a bill recycling capability where banknotes provided to the bill validator of a certain denomination are temporarily stored and available for dispensing as change through the validator. For many vending or gaming machines the protocol of the MDB (multi drop bus) controller does not have this feature as part of the standard programming. Therefore, the addition of a bill validator recycler requires replacement of the protocol or an enhancement of this protocol through an extension capability that was built into the protocol. Either of these options make installation much more difficult. For many existing machines it may be desirable to include a bill validator and recycler device however this requires a change in the protocol of the vending or gaming machine.

It is desirable to allow this additional feature for vending or gaming machines without updating of the protocol. This capability is provided in the present invention by using an intelligent adapter connected to the MDB (multi drop bus) bus for communication with the controller where the recycling capability of the banknote validator is effectively added as an additional feature of a coin changer. The intelligent adapter processes the signals to act to the host control as a bill validator and coin changer and to act as a host controller to the actual bill validator recycler and the coin changer. The intelligent and adapter effectively collects the signals of the bill validator and recycler and the coin changer and appropriately readdressing or changes them to effect the desired communication with the host controller. The protocol of the controller remains the same and is merely modified to provide an additional capability of the coin changer which is not present in the actual coin changer and use this capability for recycling of the banknote denomination or banknote denominations. The existing protocol allows for this additional capability to be added.

### SUMMARY OF THE PRESENT INVENTION

A vending or gaming device having a controller programmed for controlling at least a banknote validator and a coin changer is modified according to the present invention by an adapter to communicate with a (banknote validator and recycler). The device includes a coin changer and the banknote validator recycler. The banknote validator recycler includes an arrangement for temporarily storing accepted banknotes and dispensing temporarily stored banknotes as required to complete a transaction. The device further includes the adapter connected to the controller with the adapter acting as an intermediary as the coin changer and the banknote validator recycler are connected to the adapter. The adapter receives signals from the controller addressed to both the coin changer and the banknote validator and recycler and provides responses back to the controller. The adapter redirects some of the signals addressed to the coin changer to the banknote validator and recycler with respect to dispensing a banknote. The adapter readdresses some communications associated with banknotes to be temporarily stored or dispensed from the banknote validator and recycler to the controller to the address of the coin changer.

A vending or gaming device according to an aspect of the invention uses a MDB (multi drop bus) controller and the adapter is connected to a MDB (multi drop bus) bus of the device. The MDB (multi drop bus) protocol typically requires a response from the peripheral devices within a narrow time window that would not allow forwarding of a request from the host controller to the adapter and then to the appropriate peripheral device. To overcome this problem the adapter maintains all necessary data for each connected peripheral device as part of the virtual devices known to the host controller as well as the functionality to communicate to the host controller as the appropriate (banknote validator or coin changer) virtual device. Thus a request from the host controller to a virtual device is responded to by the intelligent adapter.

A vending or gaming device according to an aspect of the invention has the controller programmed in a manner to include a virtual capability of the coin changer to receive and/or dispense a currency amount equivalent to the denomination of banknotes stored for recycling in the banknote validator recycler and the adapter redirects any communications from the controller to the coin changer associated with the virtual capability to said banknote validator and recycler.

A vending or gaming device according to the invention comprises a controller programmed to control peripheral units connected thereto by a communication bus. The known peripheral units including at least a banknote validator and a coin changer. The vending or gaming machine includes a coin changer, a banknote validator recycler as peripheral units. The banknote validator recycler receives for later dispensing, banknotes of a predetermined denomination where the banknote validator recycler is not recognized by the controller. The controller includes programming associated with the coin changer to recycle a denomination of coins equivalent to the predetermined denomination of the banknote recycler that said coin changer is incapable of receiving and dispensing. The vending or gaming device further includes an intelligent adapter acting as an intermediary connecting the coin changer and the banknote validator recycler to the communication bus. The intelligent adapter processes signals from the banknote validator recycler to the controller such that the controller attributes the storage or the dispensing of a banknote of said predetermined denomination as originating and being controlled by the coin changer. The intelligent adapter processes communications from the controller addressed to the coin changer and associated with dispensing of currency of the predetermined denomination to the banknote recycler.

### BRIEF DESCRIPTION OF THE DRAWINGS

The above as well as other advantages and features of the present invention will be described in greater detail according to the preferred embodiments of the present invention in which;

FIG. 1 shows an existing vending or gaming machine in communication with two standard peripheral units;

FIG. 2 illustrates an existing vending or gaming machine having a new banknote validator and recycler and a coin changer connected to the controller by means of an intelligent adapter;

FIG. 3 is a schematic view of the communication between the MDB (multi drop bus) controller and the new devices with the intelligent adapter as an intermediary; and

FIG. 4 is a further schematic view of a gaming machine with the additional features of the bill recycler and the communication reconfiguration carried out by the intelligent adapter.

### DETAILED DESCRIPTION ACCORDING TO THE PREFERRED EMBODIMENTS OF THE PRESENT INVENTION IN WHICH

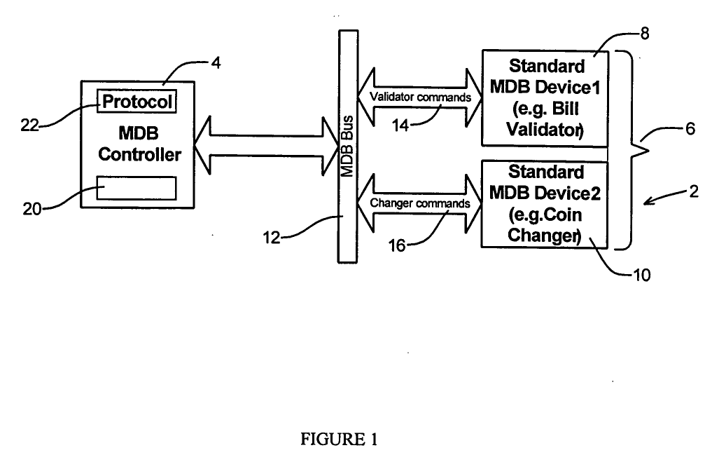

The vending or gaming machine 2 shown in FIG. 1 has a series of peripheral units 6, in this case a standard (known) bill validator 8 and a standard coin changer 10 in communication with the MDB(multi drop bus) controller 4 of the vending or gaming machine 2. The MDB (multi drop bus) controller 4 is programmed with a MDB (multi drop bus) protocol 22 to send and receive signals from the peripheral units 6 by means of the MDB (multi drop bus) bus 12. Basically the MDB (multi drop bus) controller 4 sends addressed signals to the various peripheral units and the peripheral units recognize the appropriate signals addressed to that unit and prepare and reply using the MDB (multi drop bus) 12. The MDB (multi drop bus) protocol 22 was designed to operate with a series of different known peripheral units 6 and various different capabilities of these units. For example, the protocol includes communication with a coin changer 10 however the protocol allows the coin changer to have a different number of coin tubes. Effectively, a coin tube allows the coin changer to accumulate that coin for recycling as change during subsequent transactions. The coin changer can also accept other denominations of coins but unless there is a coin tube for the particular coin, the coin will be merely deposited in a hopper for eventual removal by the user. The MDB (multi drop bus) protocol allows programming for the particular coin tubes that may be present or set for recycling.

It is a relatively straight forward process to program the protocol to allow the MDB (multi drop bus) controller 4 to control an additional coin tube for example, of a coin changer by means of the unit programming shown as 20. With this arrangement it is possible to update and/or replace a coin changer with a unit having additional features without changing of the protocol 22. This capability to modify the protocol for different known features of units applies to the other peripheral units as well.

The MDB (multi drop bus) protocol 22 was also written to allow for extensions of the protocol to accommodate additional features of peripheral units which were not known at the time of drafting of the protocol. Thus the protocol can be updated however the protocol in each vending or gaming machine must be updated if this new capability is to be incorporated in each device.

As shown in FIG. 1, the MDB (multi drop bus) controller 4 communicates with the peripheral units 6 via the MDB (multi drop bus) bus 12 and various validator commands are responded to as indicated at 14 by the bill validator 8 and various changer commands are provided or responded to by coin changer 10. These changer commands are shown as 16. Other standard peripheral units include for example display systems.

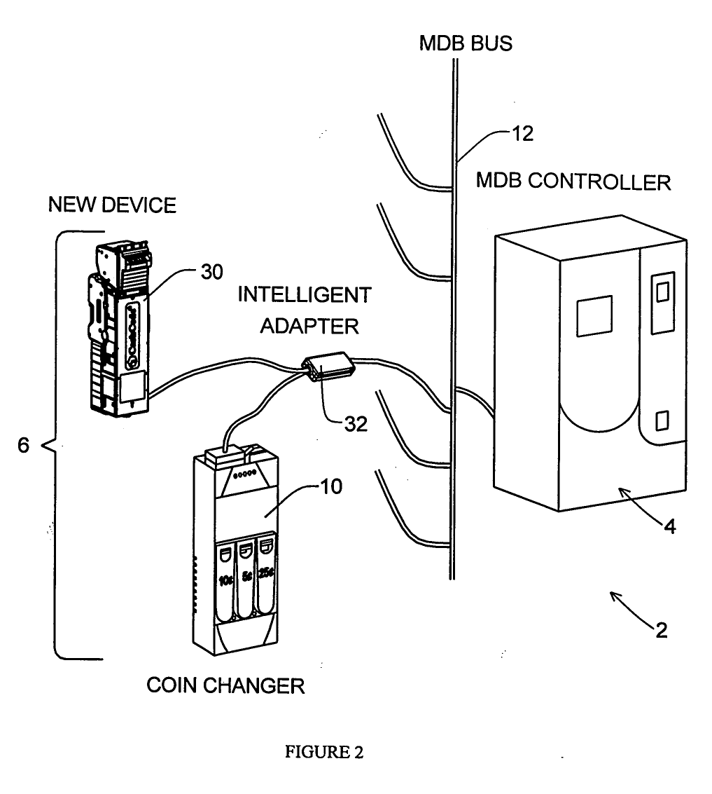

FIG. 2 shows a vending or gaming machine 2 having an MDB (multi drop bus) controller 4, a MDB (multi drop bus) communications bus 12 and a coin changer 10 in combination with a banknote validator recycler 30. Such a banknote validator recycler cannot operate directly with MDB (multi drop bus) controller 4 to use the banknote recycling capability without significant updating of the protocol. To overcome this disadvantage, an intelligent adapter 32 is provided as an intermediary between the coin changer 10 and the banknote validator recycler 30 the MDB (multi drop bus) bus 12.

The banknote validator and recycler 30 includes the standard features of a banknote validator and the command sets associated with the validation of banknotes are all recognized by the MDB (multi drop bus) controller 4 with the standard protocol. The banknote recycling function is not recognized by the MDB (multi drop bus) controller 4 without modification of the protocol. To overcome this disadvantage the intelligent adapter 32 basically separates the controller 4 from the peripheral units 30 and 10. The protocol for the MDB (multi drop bus) controller 4 is modified to include as part of the coin changer 10 the ability to collect a “virtual coin” having a denomination equivalent to the value of the banknote denomination that is to be recycled and stored. The protocol of the MDB (multi drop bus) controller can easily be modified to include this additional function of the coin changer 10. With this modification various status or command instructions for the coin changer now require additional input from the banknote validator recycler 30. In addition, certain commands for the coin changer with this virtual coin tube now must be directed to the banknote validator recycler 30 (i.e., dispensing of a coin from the virtual coin tube).

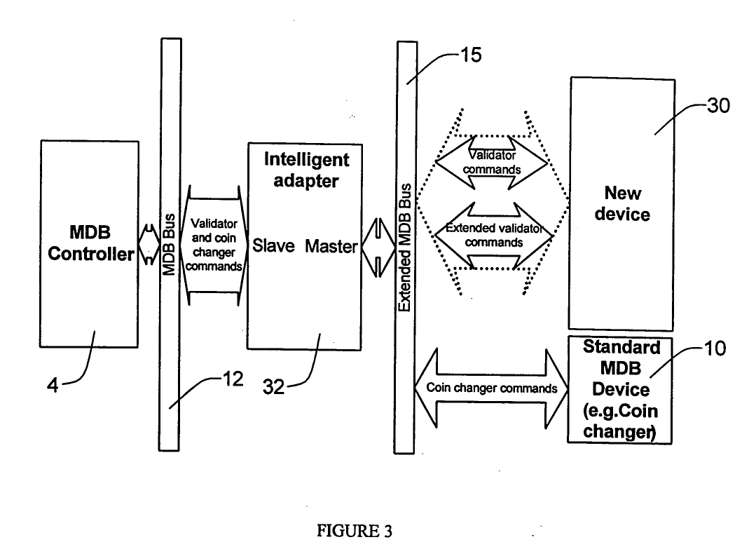

FIG. 3 shows how the adapter 32 effectively provides the desired communication between the banknote validator and recycler and the coin changer and the MDB (multi drop bus) controller in a manner to meet the respond times set by the protocol.

The intelligent adapter 32 is connected to the MDB (multi drop bus) bus 12. The intelligent adapter basically provides the current status and data of the actual coin changer and banknote validator recycler as the status of the virtual coin changer and the virtual banknote validator with the adapter ready to respond to requests from the host controller. The adapter also acts as a host controller to the actual peripheral devices and thus has the current status of these devices stored in the data of the virtual devices ready for a request from the host controller of the vending or gaming device. This arrangement allows the adapter to respond to the host controller within the relatively narrow time requirements of the protocol. For other protocols it may be possible to have the adapter recognize communications destined for the validator and the virtual coin changer with these communications passed on or modified by the intelligent adapter and communicated to the new banknote validator and recycler 30 and the standard coin changer 10.

In both of these arrangements the actual peripheral devices operate in their standard manner as if the vending or gaming machine includes an enhanced protocol that allows their direct communication. Thus as shown each of the devices 30 and 10 communicate with the extended MDB (multi drop bus) bus 15 of the adaptor and respond to signals from the intelligent adapter 32. The intelligent adapter 32 then modifies these signals for effective communication with the MDB (multi drop bus) controller 4 when required using the MDB (multi drop bus) bus 12. The intelligent adapter responds and includes the communication functionality of the virtual devices.

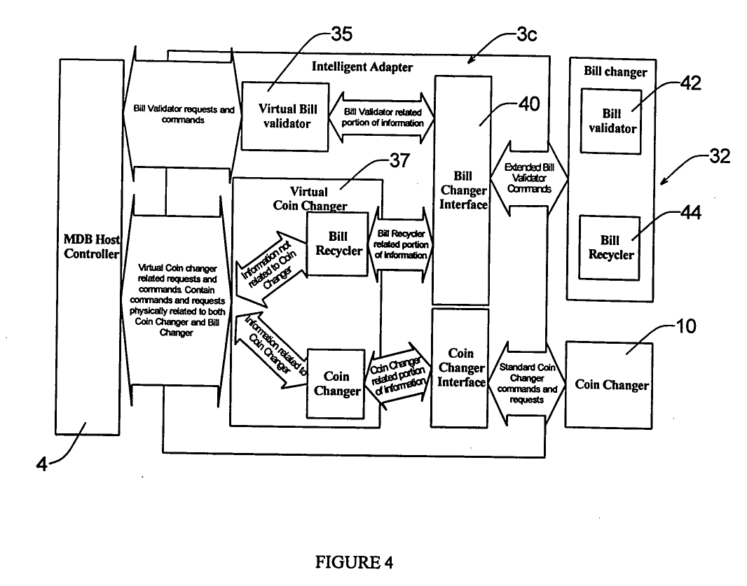

FIG. 4 shows the operation of the intelligent adapter. The MDB (multi drop bus) controller 4 communicates with the intelligent adapter 32 where the intelligent adapter responds to a virtual bill validator of a standard nature and a virtual coin changer which includes the additional coin tube having a denomination equal to the denomination of the bill recycler. As can be appreciated this approach can be duplicated to allow recycling of more than one denomination by adding more virtual coin tubes.

Bill validator requests and commands from the MDB (multi drop bus) controller 40 are received by the intelligent adapter 8 and are responded to by the intelligent adapter as the virtual devices. Some of the signals may require the actual devices to perform a task. The adapter acts as a host controller and appropriately controls the actual connected peripheral devices. The virtual coin changer 37 includes requests and commands that are associated with the bill recycler function 44 of the banknote validator and recycler 32. The intelligent adapter appropriately processes these signals and acts as a host sending appropriate signals associated with the bill recycling function to the bill changer interface 40 and subsequently to the banknote validator and recycler 32. Thus the banknote recycler 32 is functioning in its normal manner and the intelligent adapter is providing the necessary arrangement and modification of these signals. Also shown in FIG. 4 is the signals associated with the existing capability of the coin changer 10 and the adapter appropriately provides these signals to the coin changer 10. The intelligent adapter can maintain the status of the actual peripheral devices as status of the virtual devices and is ready to communicate with the host controller.

As can be appreciated from a review of FIG. 4 the intelligent adapter 32 provides a virtual bill validator 35 and a virtual coin changer 37 that communicate with the MDB (multi drop bus) host controller 4. The MDB (multi drop bus) host controller 4 has been programmed such that the virtual coin changer includes the ability to recycle a coin i.e., an additional coin tube corresponding to the denomination of the currency being stored and recycled by the bill recycler function 44. The intelligent adapter therefore modifies the signals and redirects the signals to allow this to occur without changing of the protocol to accommodate the new banknote recycler function. The protocol of the MDB (multi drop bus) controller is merely altered to define an additional capability of the coin changer that is fulfilled by the banknote recycling function.

In FIG. 4 the bill validator and recycler 32 is connected to the standard MDB (multi drop bus) system of the MDB (multi drop bus) controller 4 by means of the intelligent adapter. The protocol of the MDB (multi drop bus) host controller 4 has a protocol that does not support the bill recycler but there is support for a coin changer with an additional coin tube recycling capability. The adapter effectively splits the bill validator and the recycling capability into two standard virtual devices namely a bill validator and a coin changer. Thus the MDB (multi drop bus) controller 4 can effectively communicate with these virtual devices. Support for the bill validation functions through the virtual bill validator 35 and the bill recycling functions through the virtual changer device 37 as can be appreciated as far as the MDB (multi drop bus) host controller 4 is concerned the virtual bill validator 35 and the virtual coin changer 37 are standard devices supported by the protocol.

The adapter 32 performs processing of the MDB (multi drop bus) commands to these virtual devices by basically processing the addressed signals for the virtual bill validator 35 and the virtual coin changer 37. As previously stated the bill recycling cassette is added to the virtual changer device as an extra coin tube. All the commands related to this virtual coin tube are translated by the adapter into the extended validator commands and sent to the bill validator recycler device 32. The responses from the banknote validator and recycler are appropriately processed by the intelligent adapter and the bill recycling function is added to the coin changer signals and provided to the host controller or are used to update the status of the virtual devices.

For example, a tube status request from the MDB (multi drop bus) controller will generate the following intelligent adapter actions:
1) sending the tube status request to the coin changers and receiving tube status of the coin changer;
2) sending recycling cassettes as requested to the bill changer and receiving its recycling cassette status information;
3) combining the received information from both devices into the tube status of the virtual changer where one tube corresponds to the bill changer recycling cassette;
4) sending a response to the MDB (multi drop bus) controller.

As can be appreciated steps 1 through 3 can be performed for an actual MDB (multi drop bus) controller request and in this case the intelligent adapter may simply respond with previously formed virtual coin changer tube status.

The principles described above are also applied to the MDB (multi drop bus) controller action commands. For example, if the controller issues a dispense command or to dispense a coin of the coin type corresponding to the bill changer recycling cassette the intelligent adapter performs the following actions:
1) acknowledge receipt of the command;
2) process command parameters and determine whether the command should be directed to the coin changer or to the bill changer, split the command into coin changer and bill changer related parts and translate the bill changer related parts into the extended validator command or commands;
3) coin changer parts should be directed to the coin changer and the bill changer commands should be sent to the bill changer.

As can be appreciated the first step can be done as a last step after receiving acknowledgements from both devices It may be desirable to initially send the acknowledgement signal due to a potential timing issue associated with the MDB (multi drop bus) standards which specified that a acknowledgement signal must be received within a certain time period.

The intelligent adapter allows the new device to be added to an existing MDB (multi drop bus) system by simply plugging in the intelligent adapter as a peripheral device and connecting the device and existing coin changer to the adapter. The protocol of the MDB (multi drop bus) host controller remains the same but some additional features of the coin changer are added as outlined previously.

With the above arrangement it is possible to provide the additional banknote recycling function to existing MDB (multi drop bus) vending and gaming devices. There is no requirement to update the MDB (multi drop bus) protocol of the controller and only minor programming of additional features associated with the coin changer are required. Furthermore, there is no need to modify how the banknote validator recycler 32 operates. There is and will be new vending and gaming machines that have an enhanced protocol that recognizes a banknote validator recycler. With the system as described above the banknote validator recycler effectively operates in its standard manner and similarly the coin changer 10 also operates in its standard manner. Thus the intelligent adapter provides an effective approach for allowing existing vending and gaming machines to have the additional function of a banknote recycler added thereto without replacement of the protocol. If the protocol has been updated the intelligent adapter is not necessary.

The invention has been described with respect to a vending or gaming device that uses the MDB (multi drop bus) protocol, however this approach may also be useful for other protocols. In the embodiments described the intelligent adapter acts as a master through a communication bus with the peripherals acting as slave devices. The intelligent adapter acts as a slave peripheral device (as a combined coin changer and banknote validator) with the host controller. Current status of the virtual devices are maintained ready for response to the host controller. The adapter acts a host controller for instructing the actual connected peripheral devices. With this arrangement minimal changes to the communication protocol are necessary and the peripheral device operate in their normal manner.

Although various preferred embodiments of the present invention have been described in detail, it will be appreciated by those skilled in the art that variations may be made without departing from the spirit of the invention or the scope of the appended claims.

1. A vending or gaming device having a controller programmed for controlling at least a banknote validator and a coin changer, said device including a coin changer and a banknote validator and recycler, said banknote validator and recycler including an arrangement for temporarily storing accepted banknotes and dispensing temporarily stored banknotes as required to complete a transaction, said device further including an adapter connected to said controller with said coin changer and said banknote validator and recycler connected to said adapter, said adapter receiving signals from said controller addressed to both said coin changer and said banknote validator and recycler, effectively redirects some of said signals addressed to said coin changer to said banknote validator and recycler with respect to dispensing a banknote and said adapter readdresses some communications associated with banknotes to be temporarily stored or dispensed from said banknote validator and recycler to said controller to the address of said coin changer.

2. A vending or gaming device as claimed in claim 1 wherein said controller is an MDB (multi drop bus) controller and said adapter is connected to an MDB (multi drop bus) Bus of said device.

3. A vending or gaming device as claimed in claim 1 wherein said controller is programmed in a manner to include a virtual capability of said coin changer to receive and/or dispense a currency amount equivalent to the denomination of banknotes stored for recycling in said banknote validator and recycler and said adapter redirects any communications from said controller to said coin changer associated with said virtual capability to said banknote validator and recycler.

4. A vending or gaming device comprising a controller programmed to control peripheral units connected thereto by a communication bus, said peripheral units including at least a banknote validator and a coin changer, said vending or gaming machine including a coin changer, a banknote validator and a banknote recycler as peripheral units, said banknote recycler receiving for later dispensing banknotes of a predetermined denomination where the banknote recycler is not recognized by said controller, said controller including programming associated with said coin changer to recycle a denomination of coins equivalent to the predetermined denomination of said banknote recycler that said coin changer is incapable of receiving and dispensing, said vending or gaming device further including an intelligent adapter acting as an intermediary connecting said coin changer and said banknote recycler to said communication bus, said intelligent adapter modifying signals from said banknote recycler to said controller such that said controller attributes the storage or the dispensing of a banknote of said predetermined denomination as originating and being controlled by said coin changer, said intelligent adapter redirecting communications from said controller addressed to said coin changer and associated with dispensing of currency of said predetermined denomination to said banknote recycler.
